(19) United States
(12) Patent Application Publication
(10) Pub. No.: US 2005/0163552 A1
(43) Pub. Date: Jul. 28, 2005

(54) Printing method and image forming apparatus for performing the same

(75) Inventor: Seong-Nam Jeon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/038,268

(22) Filed: Jan. 21, 2005

(30) Foreign Application Priority Data
Jan. 28, 2004 (KR) 2004-5459

(51) Int. Cl. B41J 25/34

(52) U.S. Cl. 400/283; 400/62

(57) ABSTRACT

In an image forming apparatus using an engine part which is capable of moving in the width direction of paper fed in the print direction, a printing method has the steps of measuring a position in the width direction of paper fed in the print position, comparing measured position value with a preset reference position value, compensating a position to be printed based on the compared difference, and printing on the paper based on the compensated position data.

### CROSS-REFERENCE TO RELATED APPLICATION

This application claims the benefit under 35 U.S.C. §119(a) of Korean Patent Application No. 2004-05459 filed on Jan. 28, 2004, in the Korean Intellectual Property Office, the disclosure of which is incorporated herein by reference in its entirety.

### BACKGROUND OF THE INVENTION

1. Field of the Invention

The present invention relates to a printing method of an image forming apparatus. More particularly, the present invention relates to a printing method of an image forming apparatus which compensates for a position error of the paper in order to print normally.

2. Description of the Related Art

Generally, an image forming apparatus such as inkjet printer picks up and supplies a sheet of paper sheet by sheet from a paper supplying part using a pick up roller. The paper is arranged on a certain printing position by a feeding roller. The feature such as feeding position and speed is sensed by a sensor, such as a feeding sensor, and controlled by a control part based on the sensed information such that the whole paper can be printed.

If a paper is located in a print position, a carrier is reciprocated in the direction along the width of the paper, which is a direction perpendicular to the feeding direction, ink is jetted from the ink head at a lower part of a carrier such that it is printed in the direction of width of the paper by a line unit.

In the conventional image forming apparatus, the printing start point and end point in the width direction of paper are preset depending on the type of paper set in the printer driver. For example, if the left and right edges of A4 paper on a driver are set as a certain distance, the left and right edges of the preset paper is calculated from the set paper size, and the printing start point and end point are reset to print.

However, the paper may not be normally fed, but skewed to one side. Specifically, when feeding B5 paper which is smaller than A4, B5 paper is set on the print driver, but the paper may be skewed to one side, and therefore, may not be fed to meet the print start point and end point of a print section of B5 paper. Since the paper is out of the preset position, the print start point and end point do not meet the preset position, such that the printed output may have different margins.

### SUMMARY OF THE INVENTION

The present invention has been conceived to solve the above-mentioned problems occurring in the prior art, and an aspect of the present invention is to provide a method for an improved image forming apparatus capable of correcting a position error in the width direction of paper to print as if the paper were in the normal print position.

In order to achieve the above aspects, there is provided a printing method for an image forming apparatus using an engine part capable of moving in the width direction of paper fed to the print position, comprising the steps of measuring a position in the width direction of paper fed in the print position; comparing the measured position value with a preset reference position value; compensating the position based on the compared difference; and printing on the paper based on the compensated position data.

The measuring step may comprise the steps of measuring a print start point in the paper width direction; and measuring a print end point in the width direction of paper.

The comparing step may comprise the steps of comparing the measured start point with the reference start point; and comparing the measured end point with a the referenced end point.

The compensating step may comprise the steps of resetting the reference position data based on the comparison result between the measured position data and the reference position data; and storing temporally the reset reference position data.

In the printing step, the engine part may be moved in the width direction to print, based on the reset and stored reference position data.

### BRIEF DESCRIPTION OF THE DRAWINGS

The above and other aspects, features and advantages of the present invention will be more apparent from the following detailed description taken with reference to the accompanying drawings, in which:

FIG. 1 is a schematic view of an ink-jet printer for explaining the printing method according to an embodiment of the present invention;

FIG. 2 is a block diagram of an image forming apparatus implementing a printing method according to an embodiment of the present invention;

FIG. 3 is a flow chart of a printing method of an image forming apparatus according to an embodiment of the present invention; and

FIG. 4 is a schematic view of a printing method according to an embodiment of the present invention.

### DETAILED DESCRIPTION OF THE EXEMPLARY EMBODIMENTS

Certain embodiments of the present invention will be described in greater detail with reference to the accompanying drawings.

In the following description, it should be understood that the same drawing reference numerals are used for the same elements, features and structures throughout the drawings. The matters defined in the description such as a detailed construction and elements are provided to assist in a comprehensive understanding of the invention. Thus, it is apparent that embodiments of the present invention can be carried out without those defined matters. Also, well-known functions or constructions are omitted for the sake of conciseness.

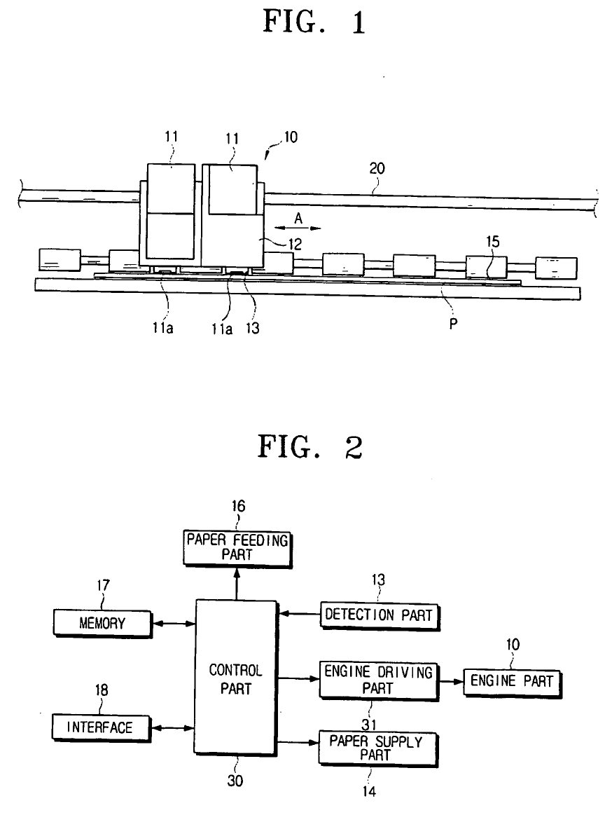

FIG. 1 and FIG. 2 are respectively a schematic view and block diagram of an ink-jet printer for explaining the printing method of an image forming apparatus according to an embodiment of the present invention.

In the ink-jet printer, an engine part 10 comprising a carriage 12 carrying an ink cartridge 11 is reciprocally mounted along a guide shaft 20. At the end part of the ink cartridge, an ink head part 11a is configured for jetting ink. A detection part 13 is configured adjacent to the ink head part 11a for detecting the position of a paper P. The detection part 13 is a sensor which preferably senses light and shade of the paper to sense the paper P or the position in the width direction A of image printed on the paper P. That is, the detection part 13 moves together with the carriage 12, emits light to one side of the paper P and receives the reflected light such that the detection part can detect the left and right ends of the paper. When the detection part 13 detects the left and right ends of paper, and if the print resolution of the engine part 10 is, for example, 600 dpi, the print start point and end point of paper in the width direction can be detected by calculating a certain dots per inch which the carriage 12 is moved from the detected paper end.

While the engine part 10 is moved in the left and right direction of the guide shaft 20, for example, in the width direction A of paper, by driving of the engine drive part 31, the engine part 10 jets ink on the paper P to print.

The paper P is fed sheet by sheet from the paper supply part 14, and moved to a certain print position by a feeding roller 15. Specifically, the paper P is moved to be passed through the lower part of the ink head part 11a. The paper is moved at a constant speed and by a regular distance in the driving of the paper feeding part 16. The feeding direction of the paper P is perpendicular to the width direction A of paper.

Various sizes of paper P can be supplied. For example, generally A4 paper and B5 paper having a smaller width than A4 paper can be used. The present embodiments will be mainly described by comparing the differences when A4 and B5 paper is used.

The driving of the paper feeding part 16, the paper supply part 14 and the engine driving part 31 is controlled by the control part 30. The control part 30 is connected to a personal computer (PC) via the interface 18 to receive the print data together with a print command. Specifically, the control part 30 receives the preset data via the printer driver of the PC, and the received data is stored in a memory 17. The printer driver can set various data such as paper size, light and shadow, and number of pages for printing. For example, if the print paper size is set as A4 paper or B5 paper, the setting data is transmitted to the control part 30, corresponding to the set paper size, and the control part 30 stores the received-set data into the memory 17.

Accordingly, the control part 30 can control the driving of the paper supply part 14, the engine drive part 31 and the paper feeding part 16 based on the various pre-stored data.

Operation of the printer will be explained with reference to an example where B5 paper having a smaller width than A4 paper is used.

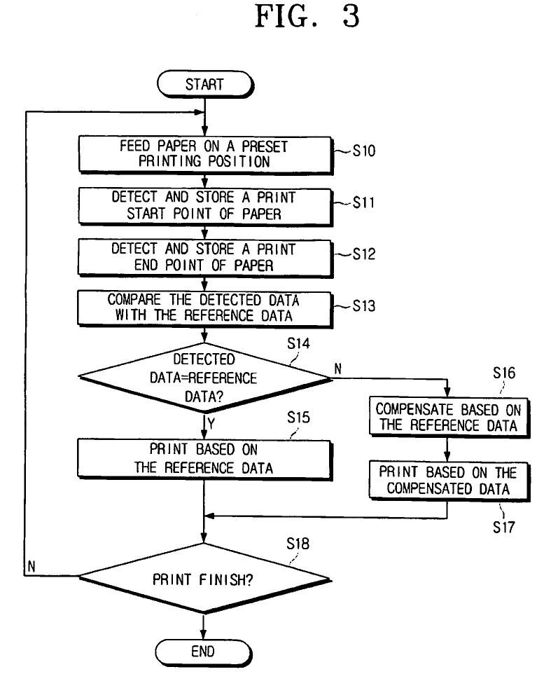

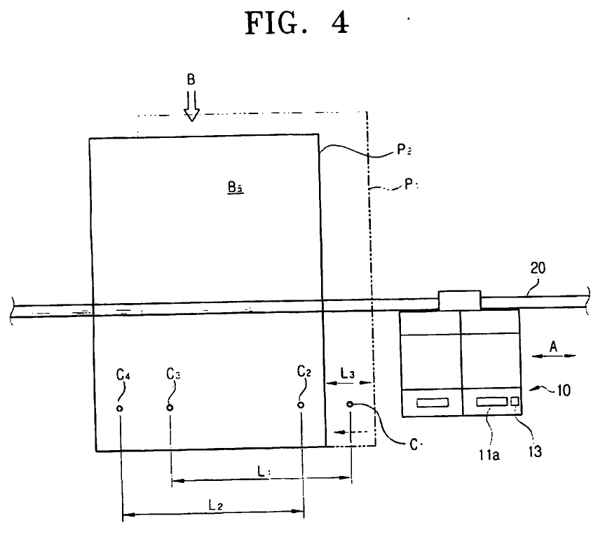

Referring to FIG. 3 and FIG. 4, if a print command is input via the printer driver, the control part 30 controls the paper feeding part 16 such that a sheet of paper P2 is picked up and moved to a preset print position (S10). If the paper P2 is moved to the preset print position and stopped, the control part 30 controls the detection part 13 such that it is detected as to whether the paper P2 is located in the right position in the width direction A.

First, the detection part 13 detects the print start point in the width direction A of paper P2 and stores the detected result (S11). Specifically, the detection part 13 moves the carriage 12 to one side to detect the print start point C2 of the fed paper P2, and stores the detected position data into the memory 17. The detection part 13 further signals for the movement of the carriage 12 to detect the print end point C4 of the fed paper P2 and store the detected result (S12).

Referring to FIG. 4, the paper P1 denotes an imaginary B5 paper, which is normally fed and located on a print position. The fed paper P2 has to fit in the set position, however, the paper P2 may be shifted in the width direction A to be improperly positioned as shown in FIG. 4. The reference position value of the print start point C1 and the print end point C3 for the imaginary paper P1 are preset and stored in the memory 17.

As described above, the position of the fed paper P2 is detected, and the detected position is compared with the reference data stored in the memory 17 (S113).

It is determined whether the compared position values are the same (S14), and if the compared values are the same based on the determined result, the paper P2 is determined to have been fed on the normal position such that printing work is directly performed (S15). The printing work is performed by the engine part 10, as the control part 30 controls the engine driving part 31.

On the other hand, if the compared results (S14), such as, the detected position value and the preset position value, are different, the reference data is compensated (S16). If printing work is performed based on the preset reference position value, the print part 10 can move only in the section L1 between C1 and C3 to print. However, because the fed paper P2 is shifted to the left side by a certain distance L3 to feed, the print start point and the print end point are added and subtracted by L3 to the left side and the print start and end points are reset as the position data of C2 and C4 to store into the memory 17.

Next, the control part 30 prints based on the reset position data, controlling the engine part 10 to jet ink only in the reset section L2 (S17).

The printing process as above may be repeated by one line unit in the width direction A of paper.

The whole fed paper P2 may be printed based on the once-compensated and reset position data.

If the print work is finished, it is determined whether any print data remains (S18) and, the print work may be continued or finished based on the determined result.

In the embodiments according to the present invention, the printing method for image forming apparatus is explained using ink-jet printer as an example. However, this should not be considered as limiting and accordingly, various apparatuses using the embodiments of the present invention are possible. For example, facsimile machines that use thermal paper, scanner or multi function device can also implement the embodiments of the present invention in the same manner as the ink-jet printer. The printing method for an image forming apparatus according to the embodiments as described above detects the position error in the width direction of the fed paper such that error can be compensated based on the detected data.

Accordingly, even when the paper is fed on another position, an image on the paper can be normally printed with regular left and right margins.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A printing method for an image forming apparatus using an engine part capable of moving in the width direction of paper fed in the print direction, comprising the steps of:
measuring a position in the width direction of paper fed in the print position;
comparing measured position value with a preset reference position value;
compensating the position based on the difference in the result of the comparing step; and
printing on the paper based on the compensated position data.

2. The printing method for an image forming apparatus according to claim 1, wherein the measuring step comprises the steps of:
measuring a print start point in the width direction of the paper; and
measuring a print end point in the width direction of the paper.

3. The printing method for an image forming apparatus according to claim 2, wherein the comparing step comprises the steps of:
comparing the measured start point with a reference start point; and
comparing the measured end point with a reference end point.

4. The printing method for an image forming apparatus according to claim 1, wherein the compensating step comprises the steps of:
resetting the reference position data based on the comparison result between the measured position data and the reference position data; and
storing temporarily the reset reference position data.

5. The printing method for an image forming apparatus according to claim 4, wherein in the printing step, the engine part is moved in the width direction to print, based on the reset and stored reference position data.

6. An image forming apparatus comprising:
a paper feeding part for feeding paper in the print direction;
an engine part for moving in the width direction of paper fed in the print direction;
a detection part for measuring a position in the width direction of paper fed in the print position;
a memory for storing preset reference position values;
a control part of comparing the measured position value with a preset reference position value, wherein the control part compensates the print position based on the difference in the comparison of the preset reference position value and the measured position value; and
printing part for printing on the paper based on the compensated position data.

7. The apparatus of claim 6, wherein the detection part comprises a light source and a light detecting device.

8. The apparatus of claim 7, wherein the detection part measures the start point and end point of the paper fed in the print direction by the feeding part.

9. The apparatus of claim 8, wherein the control part compares the measured start point with a reference start point received from the memory and compares the measured end point with a reference end point received from memory.
